(19) United States
(12) Patent Application Publication
(10) Pub. No.: US 2022/0164745 A1
(43) Pub. Date: May 26, 2022

(54) COMPUTER-BASED PLATFORM FOR CUSTOMER-INTEGRATED SUPPLY CHAIN MANAGEMENT

(71) Applicant: Bayer Aktiengesellschaft, Leveerkusen (DE)

(72) Inventors: Gregory DIBBLE, Düsseldorf (DE); Frank GÜMMER, Köln (DE); Mark SOUTHGATE, Lake St Louis, MO (US); Tao WANG, Olivette, MO (US); Vedad Boberg FAZLIC, Monheim am Rhein (DE); Verena SCHMID, Basel (CH); Jean-Remi MEUNIER, Köln (DE)

(73) Assignee: Bayer Aktiengesellschaft, Leverkusen (DE)

(21) Appl. No.: 17/602,687

(22) PCT Filed: Apr. 6, 2020
(86) PCT No.: PCT/EP2020/059711

§ 371 Date: Oct. 8, 2021

Related U.S. Application Data
(60) Provisional application No. 62/833,195, filed on Apr. 12, 2019.

(51) Int. Cl. G06Q 10/06; G06Q 30/06

(52) U.S. Cl. CPC G06Q 10/06315; G06Q 10/103; G06Q 30/0641; G06Q 30/0633

(57) ABSTRACT

An apparatus for supply-chain management includes memory storing application software coupled with an enterprise resource planning (ERP) system and processing circuitry configured execute the application software. Executing the application software causes the apparatus to generate a graphical user interface (GUI). The apparatus initiates a planning module of the GUI to build a portfolio including products and a customer, select a product, input a purchase plan, perform an analysis of the purchase plan, and output the purchase plan to a collaboration module. The apparatus initiates the collaboration module to generate a supply plan based on the purchase plan, compare the purchase plan and the supply plan to data received from the ERP system, modify the purchase plan and the supply plan, and output the modified plans to a deviation management module. The apparatus initiates the deviation management module to determine whether the modified purchase plan should be adjusted.

### CROSS REFERENCE TO RELATED APPLICATIONS

This application is a national stage application under 35 U.S.C. § 371 of International Application No. PCT/EP2020/059711, filed internationally on Apr. 6, 2020, which claims the benefit of priority to U.S. Provisional Application No. 62/833,195, filed Apr. 12, 2019.

### TECHNOLOGICAL FIELD

The present disclosure relates generally to computer-based platforms including graphical user interfaces (GUIs) and, in particular, to an improved platform and GUI for supply chain management.

### BACKGROUND

A supply chain is generally a network of entities involved in the production and distribution of a product from supplier to customer. The supply chain may include supplier and customer locations from which the product is shipped and received, either or both of which may be a warehouse. The supply chain may also include a shipping company responsible for shipping the product from the supplier to the customer. Even further, the supply chain may additionally include a number of technologies that facilitate the production and distribution of the product from supplier to customer.

In some industries, the supplier uses a computer-implemented enterprise resource planning (ERP) system to manage many of its business processes including the distribution of products to various supplier locations, as well as to customer locations. These receiving locations may also use the ERP system to manage and track shipments of product into and out of those locations. In cases of a third-party shipping company, the shipping company may utilize a similar system—or more generally a computer-implemented back-office support system—to manage and track shipments.

### BRIEF SUMMARY

In view of the foregoing background, example implementations of the present disclosure are directed to an improved system to interface with a computer-implemented enterprise resource planning (ERP) system for inventory management.

In some embodiments, a method of supply chain management from an apparatus with application software coupled with an enterprise resource planning (ERP) system via middleware may comprise:
1. executing the application software to cause the apparatus to generate a visual environment including a graphical user interface (GUI), including the apparatus;
2. initiating a planning module of the GUI for:
   a. building a portfolio including one or more products and based at least in part on a plurality of input data feeds and selected criteria including a customer;
   b. selecting a product of the one or more products and inputting a purchase plan based at least in part on the selected product and the customer; and
   c. performing an analysis of the purchase plan and outputting the purchase plan to a collaboration module of the GUI;
3. initiating the collaboration module for:
   a. generating a supply plan based on the purchase plan;
   b. comparing the purchase plan and the supply plan to transactional data received from the ERP system via the middleware;
   c. modifying the purchase plan and the supply plan based at least in part on communication between the customer and an application manager after the comparing step; and
   d. outputting the modified purchase plan and the modified supply plan to a deviation management module of the GUI; and
4. initiating the deviation management module for:
   a. determining whether the modified purchase plan should be adjusted based on a deviation value that is calculated when a deviation exists in the modified purchase plan; and
   b. performing a task to delete, roll, or custom roll the deviation value in the modified purchase plan based on the determining step.

In some embodiments, an apparatus for supply chain management may comprise:
1. a memory storing application software coupled with an enterprise resource planning (ERP) system via middleware; and
2. processing circuitry configured to access the memory and execute the application software to cause the apparatus to generate a visual environment including graphical user interface (GUI), including the apparatus being caused to at least:
   a. initiate a planning module of the GUI, the planning module configured to:
      i. build a portfolio including one or more products and based at least in part on a plurality of input data feeds and selected criteria including a customer;
      ii. select a product of the one or more products and inputting a purchase plan based at least in part on the selected product and the customer; and
      iii. perform an analysis of the purchase plan and outputting the purchase plan to a collaboration module of the GUI;
   b. initiate the collaboration module configured to:
      i. generate a supply plan based on the purchase plan;
      ii. compare the purchase plan and the supply plan to transactional data received from the ERP system via the middleware;
      iii. modify the purchase plan and the supply plan based at least in part on communication between the customer and an application manager after the comparison; and
      iv. output the modified purchase plan and the modified supply plan to a deviation management module of the GUI; and
   c. initiate the deviation management module configured to:
      i. determine whether the modified purchase plan should be adjusted based on a deviation value that is calculated when a deviation exists in the modified purchase plan; and
      ii. perform a task to delete, roll, or custom roll the deviation value in the modified purchase plan based on the determination.

In some embodiments, a non-transitory computer-readable storage medium for supply chain management having stored therein computer-readable program code coupled with an enterprise resource planning (ERP) system via middleware and executable by processing circuitry may be configured to cause an apparatus to:
1. generate a visual environment including graphical user interface (GUI), including the apparatus being caused to at least:
   a. initiate a planning module of the GUI, the planning module configured to:
      i. build a portfolio including one or more products and based at least in part on a plurality of input data feeds and selected criteria including a customer;
      ii. select a product of the one or more products and inputting a purchase plan based at least in part on the selected product and the customer; and
      iii. perform an analysis of the purchase plan and outputting the purchase plan to a collaboration module of the GUI;
   b. initiate the collaboration module configured to:
      i. generate a supply plan based on the purchase plan;
      ii. compare the purchase plan and the supply plan to transactional data received from the ERP system via the middleware;
      iii. modify the purchase plan and the supply plan based at least in part on communication between the customer and an application manager after the comparison; and
      iv. output the modified purchase plan and the modified supply plan to a deviation management module of the GUI; and
   c. initiate the deviation management module configured to:
      i. determine whether the modified purchase plan should be adjusted based on a deviation value that is calculated when a deviation exists in the modified purchase plan; and
      ii. perform a task to delete, roll, or custom roll the deviation value in the modified purchase plan based on the determination.

Features, aspects, and advantages of the present disclosure will be apparent from a reading of the following detailed description together with the accompanying drawings, which are briefly described below. The present disclosure includes any combination of two, three, four or more features or elements set forth in this disclosure, regardless of whether such features or elements are expressly combined or otherwise recited in a specific example implementation described herein. This disclosure is intended to be read holistically such that any separable features or elements of the disclosure, in any of its aspects and example implementations, should be viewed as combinable, unless the context of the disclosure clearly dictates otherwise.

### BRIEF DESCRIPTION OF THE DRAWING(S)

Having thus described the disclosure in general terms, reference will now be made to the accompanying drawings, which are not necessarily drawn to scale, and wherein:

FIG. 1A illustrates an exemplary system for supply chain management, according to some embodiments of the present disclosure;

FIG. 1B illustrates the system of FIG. 1A including multiple apparatuses, according to some embodiments of the present disclosure;

FIG. 2 shows a flowchart illustrating various steps in a method of managing a supply chain, according to some embodiments of the present disclosure;

FIGS. 3A, 3B, 3C, and 3D show flowcharts illustrating various steps in a method of supply chain management, according to some embodiments of the present disclosure;

FIG. 4 illustrates an apparatus according to some embodiments of the present disclosure;

FIG. 5A illustrates a planning module of a graphical user interface (GUI), according to some embodiments of the present disclosure;

FIGS. 5B, 5C, 5D, and 5E illustrate additional features of the planning module of the GUI shown in FIG. 5A, according to some embodiments of the present disclosure;

FIG. 6 illustrates a collaboration module of the GUI, according to some embodiments of the present disclosure; and

FIGS. 7A and 7B illustrate a deviation management module of the GUI, according to some embodiments of the present disclosure.

### DETAILED DESCRIPTION

Some embodiments of the present disclosure will now be described more fully hereinafter with reference to the accompanying drawings, in which some, but not all implementations of the disclosure are shown. Indeed, various implementations of the disclosure may be embodied in many different forms and should not be construed as limited to the implementations set forth herein; rather, these example implementations are provided so that this disclosure will be thorough and complete, and will fully convey the scope of the disclosure to those skilled in the art. As used herein, for example, the singular forms “a”, “an”, “the” and the like include plural referents unless the context clearly dictates otherwise. The terms “data”, “information”, “content” and similar terms may be used interchangeably, according to some example implementations of the present invention, to refer to data capable of being transmitted, received, operated on, and/or stored. Also, for example, reference may be made herein to quantitative measures, values, relationships or the like. Unless otherwise stated, any one or more if not all of these may be absolute or approximate to account for acceptable variations that may occur, such as those due to engineering tolerances or the like. Like reference numerals refer to like elements throughout. Depending on the context, the word “actuals” as used herein may refer to actual sales occurring or the actual delivery of supply that was pre-positioned into a customer's warehouse.

As explained in the Background section, in a typical supply chain, a computer-implemented enterprise resource planning (ERP) system may be used to manage the distribution of products to various supplier locations, as well as to customer locations. Some embodiments of the present disclosure may address, among other things, the problem of improving customer-supplier engagement and communication during the process of supply chain management.

In particular, some embodiments of the present disclosure may provide application software executable to generate a visual environment including a graphical user interface (GUI) to perform supply chain management. The application software may connects to the ERP system via middleware that allows the user to utilize the application software to do the process without having to directly engage the ERP system. In some embodiments, the application software may also capture necessary information to enable the customer and the supplier to address supply chain issues and view relevant data analytics to update purchase plans and supply plans as appropriate.

There are various considerations when implementing supply chain management via application software, including generating an aligned demand-and-supply expectation at the beginning of the season, managing those expectations against actual developments throughout the season, and managing the deviations for the previous month and the impact of those deviations on the current month and future months.

In some embodiments, the application software may focus on a single customer at a time. This focus may include a territory of the customer, which territory the customer endeavors to maximize from one of its distribution centers (which may serve its own retail stores, independent retailers, and/or growers). This focus may be configured to remain the same through the process flow.

Some embodiments may provide a method for supply chain management including processes implemented in a GUI of the application software, including: demand and supply management (also referred to as collaboration); exchange; analytics; logistics; metrics; training; deviation management (also referred to as M2M); and planning (also referred to as business planning).

Business planning may pertain to establishing and outputting an aligned baseline purchase plan for the products that serve the customer territory in focus. During the business planning process, additional plans may be generated, including: a baseline supply plan, a baseline inventory development plan for Supplier-owned stocks in the customer warehouse, and a channel inventory development outlook for the business of the customer to retailers and growers. These additional plans may generate data for use in analytics and/or points of interest that improve the overall customer experience.

A sub-process of the business planning process may include preparing a portfolio for the customer territory including one or more products. This may involve certain designated roles within the application software (e.g., an application manager and an account manager). The baseline purchase plan may be generated here, as well as a pre-planning report for the customer. The pre-planning report may be generated via an image-rendering process providing automated and standardized pre-reads for the customer stakeholders prior to any group meetings wherein the customer, application manager, and account manager may revise the portfolio and the purchase plan.

Another sub-process may include meetings between the customer, the application manager, and the account manager, wherein the application software is used to further refine and come to a final alignment on the baseline purchase plans for the products in the portfolio.

Another sub-process may include generating a post-planning report after the purchase plan has been aligned. The post-planning report may be based on input received from a collaboration process/module.

Various incoming data feeds may be received and utilized by the application software, including: historical purchase data of a customer purchasing from a supplier, and historical purchase data of a retailer/grower purchasing from the customer. The historical purchase data feeds may be received and displayed in the planning module of the GUI when a particular product is selected for a customer territory. Various master data settings and territory data clusters may also be used by the application software to define the customer territory and connect the historical data to the customer territory.

Collaboration may involve analysis of the purchase plan and a supply plan that is generated based on the purchase plan. The collaboration may be managed for predetermined time intervals (e.g., months). Transactional data may be inputted to the collaboration process and compared to and/or analyzed along with the purchase plan and the supply plan. The transactional data may be updated at predetermined time intervals (e.g., daily) to provide relevant information concerning the actual products in the supply chain compared to the plans. The updating of transactional data may be performed by the application software obtaining the transactional data from middleware, which obtains the transactional data from the ERP system.

The collaboration process may facilitate demand and supply information for the product serving the territory being organized in one place, thereby allowing evaluation of the purchase plan and the supply plan as well as collaborative communication between users (e.g., the application manager and the customer). Actions performed within the collaboration process may occur in a nonlinear/non-sequential order because of the real-time management of the purchase plan and the supply plan.

Within the collaboration process, collaborative communication may be in the form of a conversation such that the customer and the application manager can discuss demand for a product in the territory. Conversation bubble icons may be present in the collaboration module, and clicking on the icons may initiate a dialog box where the customer can enter details related to a purchase plan change in the month of concern. The customer may save the entered details in the dialog box and send them to the application manager by clicking a button, which may send the entered details via email. The sent communication (email) may include the details of the customer territory, the product of concern, and the contextual inputs (contextual inputs may refer to details concerning why changes were requested for the purchase plan, e.g., weather conditions, shortages of a product, etc.) The application manager may use the sent communication to validate the situation, update the purchase plan and the supply plan, and then respond to the customer using the same conversation bubble icon and dialog box to provide updated information. Updating the purchase plan may involve manual updating by the application manager. The supply plan may be auto-generated through heuristic logic that makes adjustments to the supply plan.

For example, when a month-end inventory is projected to be negative, the output of the heuristic logic may be based on taking the amount of the negative inventory and adding an amount equal to one month of inventory. This updated amount compensating for projected negative inventory may be proposed for the supply plan in the month of the projected shortage. If such a proposal is not feasible/ideal, then the application manager may override the supply plan such that the heuristic logic is not used.

Logistics information may be available in the collaboration process to allow a user to be notified when a product is in transit. Such notifications may include a clickable icon or link that allows the user to obtain more information regarding the product shipment. A user may also be able to see current available inventory at the customer warehouse in real-time via a remote function call from the application software to the ERP system.

Deviation management may include accounting/compensating for deviations present in the purchase plan and supply plan output from the collaboration process for the previous month. The deviation management process determines what the deviation means for the current and future months, including determining whether the purchase plan needs to be adjusted based on the deviation.

The deviation management process (also referred to as month-to-month (“M2M”) management) may be performed within a predetermined time interval related to the collaboration process (e.g., within two days after the end of the previous month). In keeping with this example, on a first day of each new month, an internal process may be run by the application software for each territory-customer combination in order to identify which purchase plans are either greater than or less than the total purchases in the previous month, thereby identifying a deviation. The identified purchase plans may be populated in a list that is reviewable by the application manager.

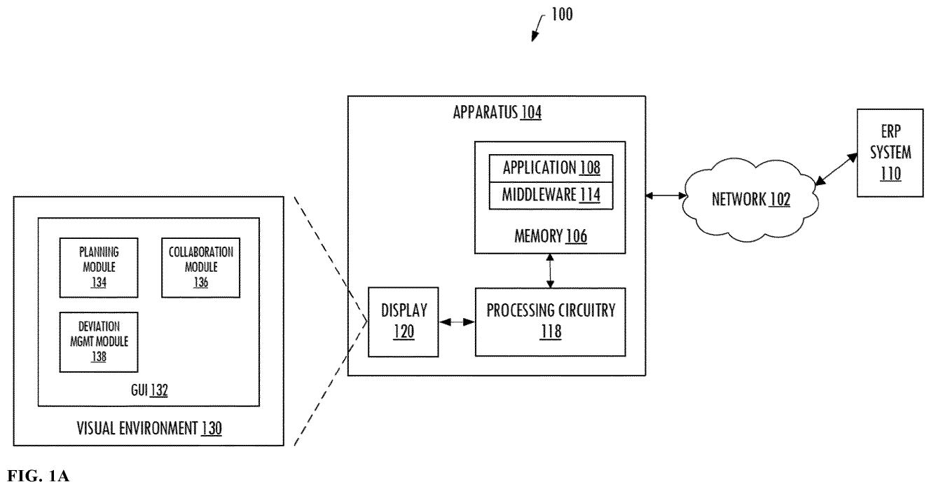

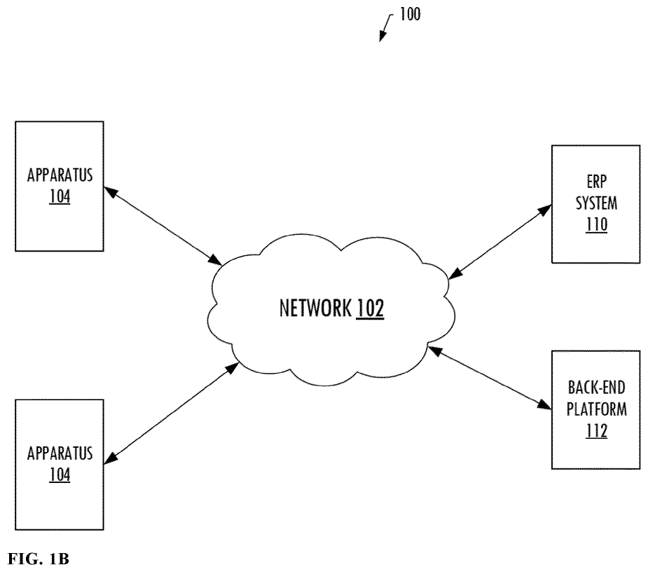

FIG. 1A illustrates a system 100 according to some embodiments of the present disclosure. The system 100 may perform at least the method of any preceding example implementation, or any combination of any preceding example implementations. The system 100 may include any of a number of different subsystems (each an individual system) for performing one or more functions or operations. As shown, the system may be implemented with an Internet-based computing architecture including a computer network or a number of interconnected computer networks 102 in or over which a number of systems, platforms, computers and the like communicate or otherwise operate.

As also shown, in some embodiments, the system may includes an apparatus 104 with a memory 106 storing application software 108 coupled with an ERP system 110 via middleware 114. In some embodiments, in the supply chain, the apparatus and ERP system are may be operable by a supplier, customer, and/or shipping company responsible for shipping product to a receiving location of the supplier or customer.

In some embodiments, the apparatus 104 further includes processing circuitry 118 configured to access the memory 106, and execute the application software 108 to cause the apparatus 104 to generate on a display 120 a visual environment 130 including a graphical user interface (GUI) 132. This may includes the apparatus 104 being caused to access the ERP system 110 to obtain historical information from various data feeds.

In some embodiments, the apparatus 104 is may be caused to execute various modules in the GUI 132 including the planning, collaboration, and deviation management modules 134, 136, and 138, respectively.

In some embodiments, the apparatus 104 is may be caused to determine if a deviation exists in a purchase plan. In some embodiments, the deviation is may be applied to the purchase plan such that the purchase plan is adjusted using a deviation value that is based on the determined deviation. In some embodiments, the deviation value may be added to the purchase plan or may consume the purchase plan depending on whether the deviation in the purchase plan causes the purchase plan to be greater than or less than a number of total purchases.

As shown in FIG. 1B, in some embodiments, system 100 may have multiple apparatuses 104 that interact with one another through the network 102 as part of supply chain management. In some embodiments, an apparatus 104 may be controlled and/or operated by a supplier, and another apparatus 104 may be controlled and/or operated by a customer. The back-end platform 112 may support communication and synchronization between the multiple apparatuses 104 as part of supply chain management.

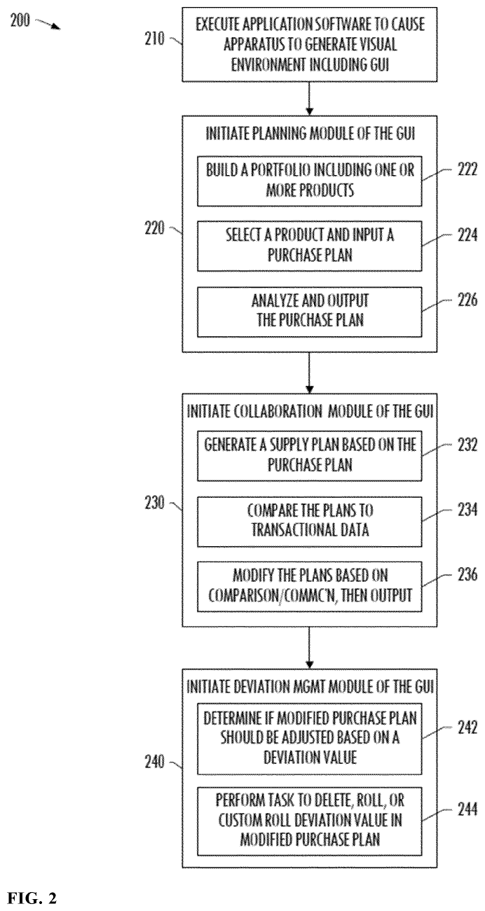

FIG. 2 shows a flowchart illustrating various steps in a method 200 of managing a supply chain from an apparatus 104 with application software 108 coupled with an ERP system 110 via middleware 114, according to some embodiments. As shown at block 210, the method may includes executing the application software to cause the apparatus to generate a visual environment including a GUI. Method 200 may also includes the apparatus initiating a planning module of the GUI, as shown at block 220, for: building a portfolio including one or more products and based at least in part on a plurality of input data feeds and selected criteria including a customer (as shown at block 222); selecting a product of the one or more products and inputting a purchase plan based at least in part on the selected product and the customer (as shown at block 224); and performing an analysis of the purchase plan and outputting the purchase plan to a collaboration module of the GUI (as shown at block 226).

The method 200 may also includes the apparatus initiating the collaboration module, as shown at block 230, for: generating a supply plan based on the purchase plan (as shown at block 232); comparing the purchase plan and the supply plan to transactional data received from the ERP system via the middleware (as shown at block 234); modifying the purchase plan and the supply plan based at least in part on communication between the customer and an application manager after the comparing step (as shown at block 236); and outputting the modified purchase plan and the modified supply plan to a deviation management module of the GUI (as shown at block 236).

The method 200 may also includes the apparatus initiating the deviation management module, as shown at block 240, for: determining whether the modified purchase plan should be adjusted based on a deviation value that is calculated when a deviation exists in the modified purchase plan (as shown at block 242); and performing a task to delete, roll, or custom roll the deviation value in the modified purchase plan based on the determining step (as shown at block 244).

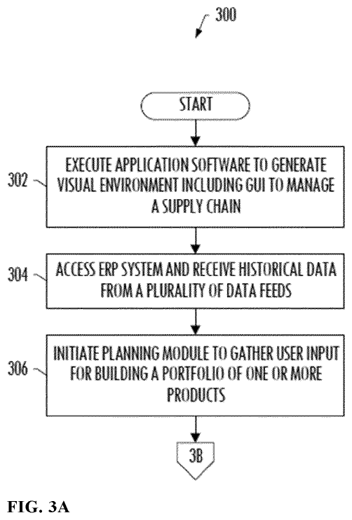

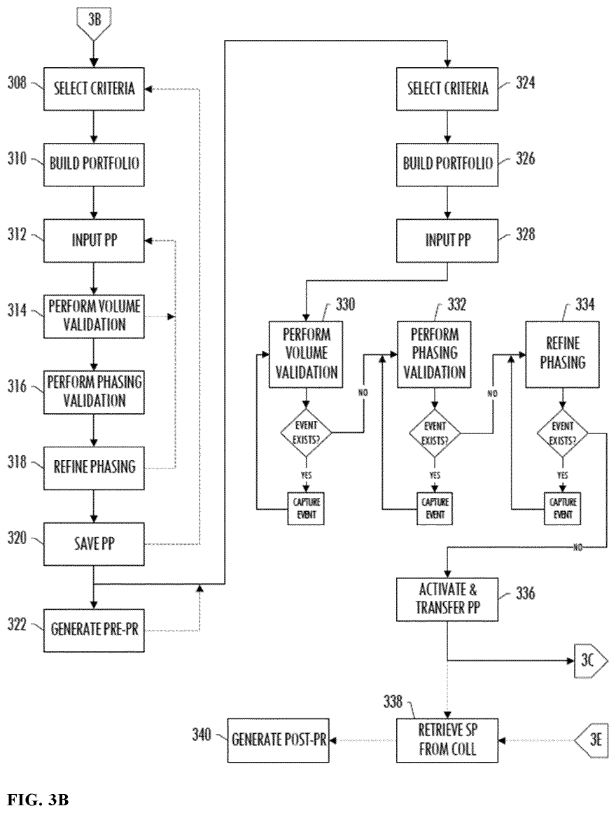

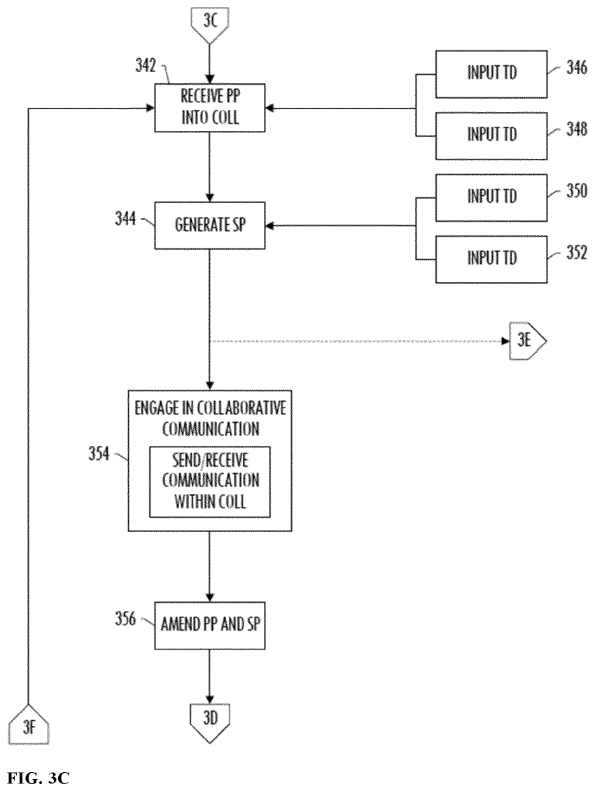

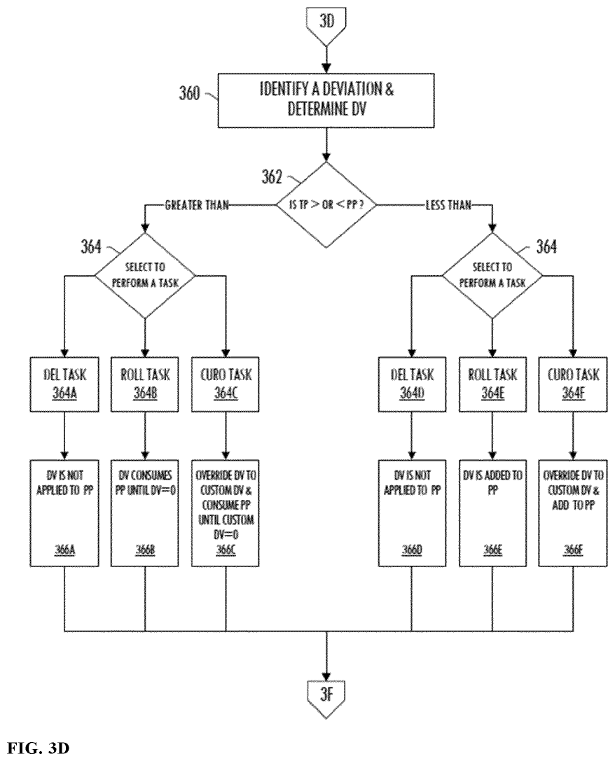

FIGS. 3A, 3B, 3C, and 3D show flowcharts illustrating various steps in a method 300 of supply chain management, according to some embodiments of the present disclosure. The following acronyms are used in, or in relation to, the flowcharts:
ACCM—account manager
AM—application manager
COLL—collaboration module
CUS—customer
CURO—custom roll task
DEL—delete task
DEV—deviation management module
DV—deviation value
PLA—planning module
PP—purchase plan
PR—planning report
ROLL—roll task
SP—supply plan
TD—transactional data
TP—total purchases

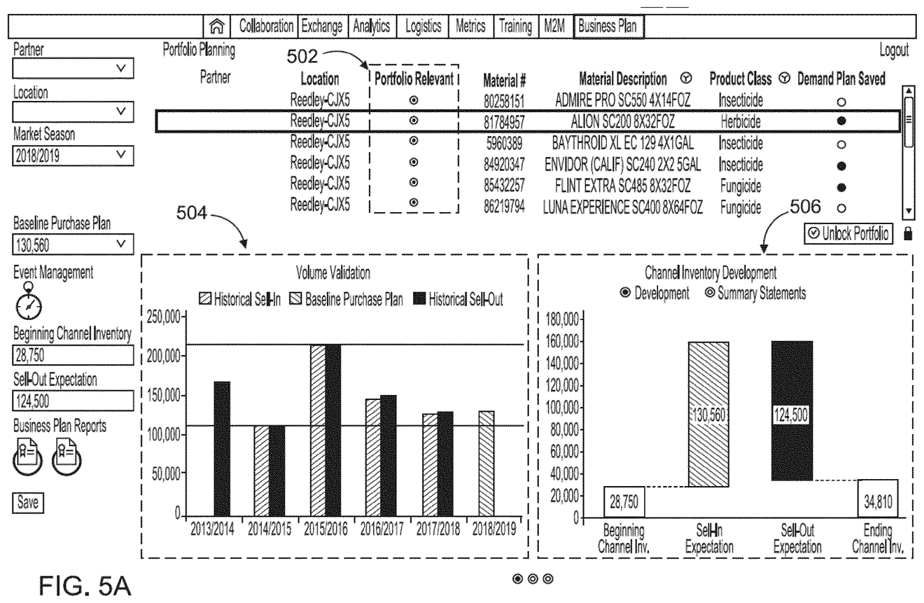

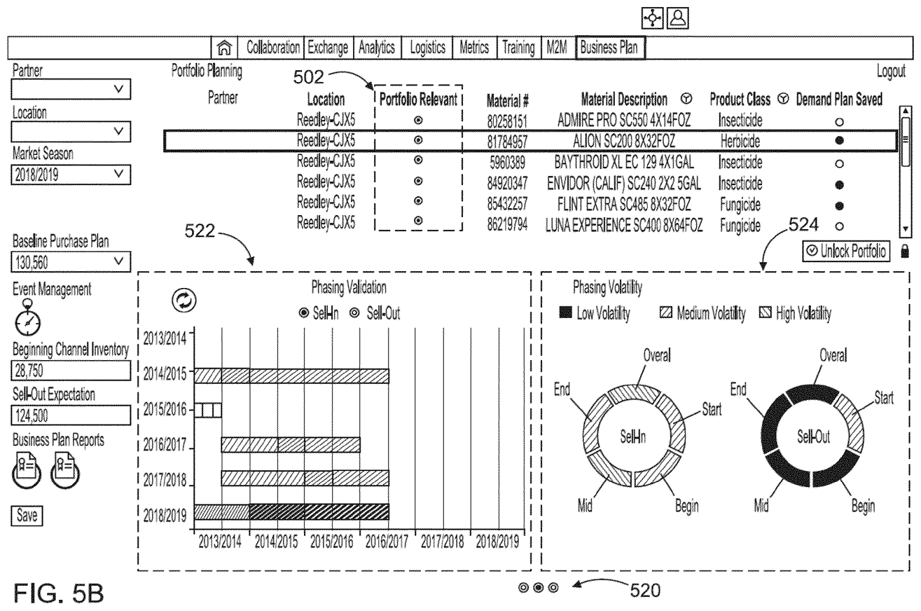

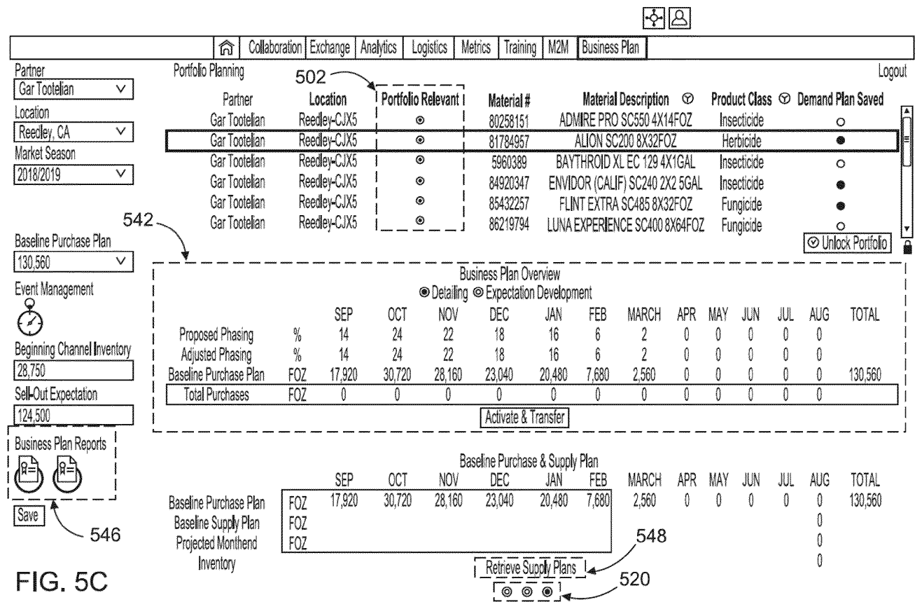

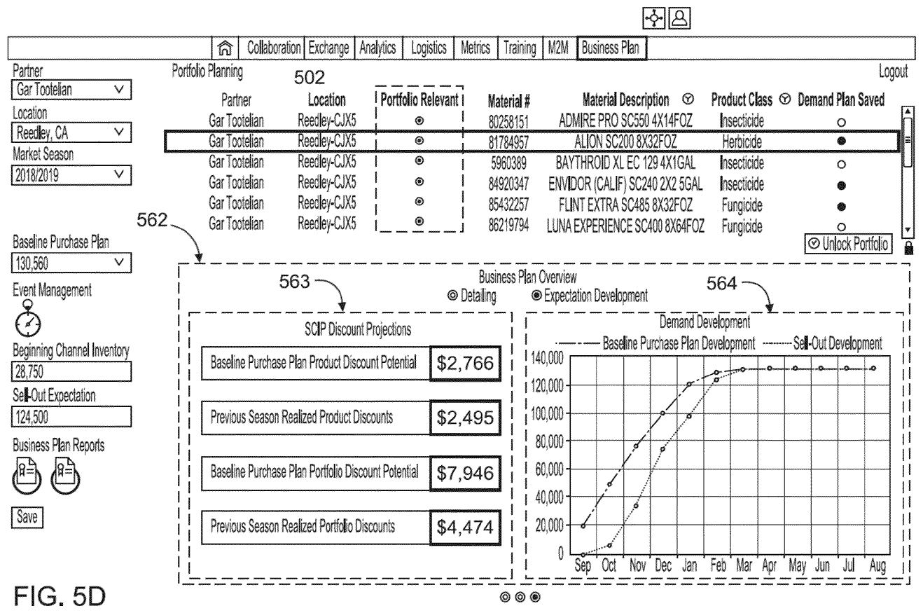

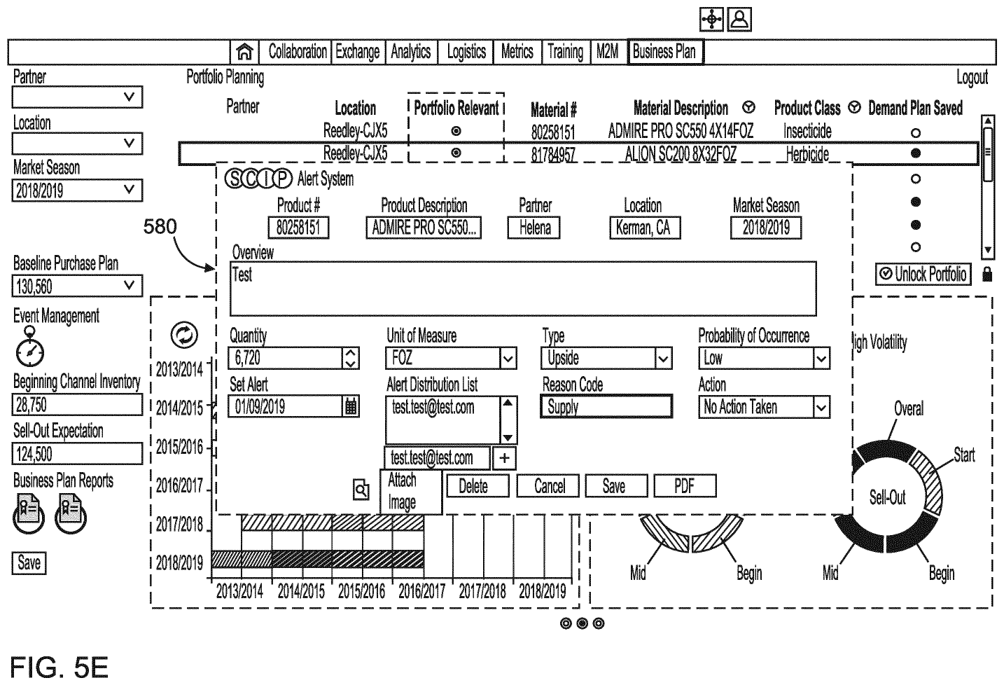

Turning now to FIG. 3A, in a manner similar to that described above, the method 300 may include executing application software 108 to cause the display 120 in the apparatus 104 to generate a visual environment 130 including a GUI 132 to manage a supply chain, as shown at block 302. This may include the apparatus 104 accessing the ERP system 110 and receiving historical data from a plurality of data feeds, as shown at block 304. It may also include the apparatus 104 initiating a planning module (PLA) in the GUI (as shown in FIG. 5A) to gather user input for building a portfolio of one or more products, as shown at block 306.

As shown at block 308 of FIG. 3B, the initiated PLA may allow a user (AM) to select criteria including CUS, CUS territory, and a market season. Once the criteria are selected, AM and AccM may build a portfolio, including one or more products, for the CUS territory, as shown at block 310. This may be performed by selecting a product displayed in the PLA (e.g., by marking a product as “portfolio relevant” (see region 502 in FIG. 5). As shown at block 312, AM and AccM may select a product and input a PP for the CUS territory-product combination (which may include inputting a volume expectation for the product).

As shown at block 314, once the PP is inputted, the value of the PP may be displayed in the “volume validation” chart and the “channel inventory development” chart in the PLA (see respective regions 504 and 506 in FIG. 5A). In the “volume validation” chart (region 504), the PP may be shown in comparison to previous market season actual purchases and channel sales. These visual indicators may aid in validating the feasibility of the PP. In the “channel inventory development” chart (region 506), the PP may be shown as the “sell-in expectation” bar, along with two other captured inputs “beginning channel inventory” and “sell-out expectation”. These data representations may describe the current inventory position of the CUS for their product in the territory, as well as their expectation of what will be sold to retailers/growers in the territory. With these values, the PLA can show a projection of “ending channel inventory” in the “channel inventory development” chart (region 506) for the product in the territory at the end of the market season. Depending on determinations made by the AM and AccM based on the data representations related to block 314, the AM and AccM may return to block 312 to adjust the PP.

After the PP is accepted based on block 314, the AM and AccM may select a radio button in the PLA (see region 520 in FIG. 5B) to validate phasing of the PP, as shown at block 316. A “phasing validation” chart (region 522) may be displayed showing the last 5 market seasons of TD for sales between supplier and CUS, as well as CUS and retailer/grower. This chart shows the market season segmented into three tiers (beginning, middle, and end) and with a percentage of sales volume removed to minimize the impact of outliers on the data visualization (e.g., the first and last 3% of sales volume may be removed). The segmenting of the market season into thirds is based on cumulating the market season on a percentage basis and subsequently splitting the market into three tiers, as shown in region 522.

An algorithm may be applied to pre-select the most common phasing pattern based on starting and ending time intervals (e.g., months) of the market season. The algorithm may first identify the starting time interval that occurs most often based on history (from the TD), e.g., the algorithm may identify where the start of the season (month a±1 month) and the end of the season (month n±1 month) have more than one instance/occurrence over the market seasons that are presented in the GUI (see region 522). If there are no instances where the market seasons have an algorithmic match for the start and end of the season, then the algorithm uses the previous market season as a reference point for the phasing proposal that is provided for the present market season, i.e., if no common pattern is distinguishable, then the last market season is considered the reference point. The algorithm may thereby provide a phasing proposal based on the described set of rules; however, it is possible for a user (e.g., AM or AccM) to override the proposal of the algorithm by selecting and/or deselecting market seasons in the “phasing validation” chart, thereby updating the final proposal. The final proposal is the average distribution over the selected seasons.

The “phasing volatility” chart (region 524 in FIG. 5B) may be used by the AM and AccM for additional information on the volatility of the different tiers. The application software may check how often a season had similar starting months over a previous predetermined time interval (e.g., 5 years) and determine a level of volatility based on the result of the check. In some embodiments, the occurrence of a similar starting month at least three times may be considered/labeled as “low volatility”; a similar starting month two times may be considered “medium volatility”; and less than two similar starting months may be considered “high volatility.”

After the phasing related to block 316 is completed, the AM and Accm may select another radio button in the PLA (see region 520 in FIG. 5C) to refine the phasing of the PP, as shown at block 318. In the GUI, a user may view a “business plan overview” grid (region 542) including the proposed phasing as derived from the “phasing validation” chart in FIG. 5B. An adjusted phasing percentage distribution may also be shown, which changes when the PP values are adjusted. Total purchases to-date may also be shown for the product in the territory, which may be used as a reference/alignment values.

A user may also select an “expectation development” button, as shown in region 562 of FIG. 5D, to view the values charted (sub-region 564) and to view the expected discounts (sub-region 563) associated with the PP for the product and the portfolio for the market season as compared to a previous time interval (e.g., a previous year). After refining the phasing related to block 318, various actions may be taken. The method may return to block 312 to update the inputs to the PP. Alternatively, the PP may be saved, as shown at block 320. After saving, the method 300 may return to block 308 to perform the actions associated with blocks 308-320 for the remaining “portfolio relevant” products.

When the portfolio has been fully planned for all of the “portfolio relevant” products and the PP is saved as shown at block 320, a pre-PR may be generated, as shown at block 322 by selecting a “business plan reports” icon (see region 546 in FIG. 5C). The pre-PR may include each product in the portfolio may be displayed with details pertaining to the PP, volume validation, phasing validation, and the “business plan overview” grid. Generation of the pre-PR may render the aforementioned selected chart images based on the last time that they were viewed by the AM and AccM and includes the charts in the pre-PR with the relevant values. Generating the pre-PR provides the benefit of automating a working document that can be sent to a target audience, such as the CUS, prior to a meeting where the PP is discussed/reviewed. Providing access to the report may aid in engaging the CUS prior to the meeting in order to maximize the effectiveness of the meeting and may provide a better CUS experience with respect to supply chain management.

The saved PP from block 320 may be utilized as input associated with blocks 324 to 334 (with the pre-PR as a potential additional input), wherein the actions of blocks 324 to 334 are another iteration of blocks 308 to 318, respectively. The differences in this iteration (blocks 324 to 334) are that the CUS is included, and during blocks 330 to 334 the users (AM, AccM, and CUS) have the opportunity to capture an “event”—an incident that is product territory specific and is considered to be an “upside” or “downside” with a probability of occurrence that is less than the input PP (see FIG. 5E, showing region 580 displayed as a pop-up window for entering event details). An “upside” refers to a probability of sales occurring above the PP due to a market/regulatory event, whereas a “downside” refers to the probability of sales occurring below the PP due to a market/regulatory event.

As shown in region 580, an event may be captured with information concerning the volume of the event, the probability of occurrence, the reason for the event, contextual information about the event, and other relevant attachments. A distribution list of stakeholders may be associated with the event and may be notified on an alert date, whereupon the aforementioned event information is sent to the distribution list.

Upon completion of the actions associated with block 334 (which is an iteration of block 318), the PP may be “activated and transferred” such that it is output to the COLL, as shown at block 336. The PP of each “portfolio relevant” product may be revised/updated as described above.

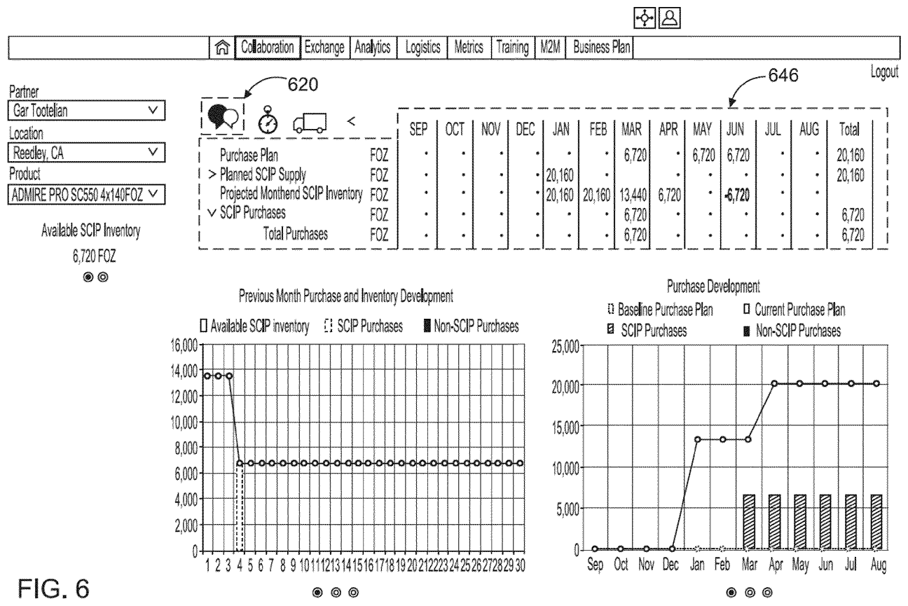

When the PP is received in the COLL, as shown at block 342 of FIG. 3C, an SP may be generated based on the PP, as shown at block 344. The PP may be considered the official aligned forecast for a product serving a CUS territory and may drive supply planning (see block 344) and monitoring against actuals. In some embodiments, the PP and SP may be managed in real-time in the COLL. As shown in FIG. 6, the CUS and Supplier may have real-time visibility to the PP and SP, as well as actuals as they develop in the current time interval (e.g., month) and season.

After the SP is generated, it may be retrieved by the PLA at any time by a user clicking a button in the PLA (see region 548 in FIG. 5C, showing “retrieve supply plans” button). By this action, the PLA may fetch the SP of a related PP, as shown at block 338 of FIG. 3B. The retrieved SP may then be utilized along with the PP output from block 338 to generate a post-PR, as shown at block 340. In keeping with block 340, the post-PR may be generated by selecting another “business plan reports” icon in region 546. The post-PR may include each product in the portfolio displayed with details previously discussed with respect to the pre-PR but also including information from the SP. The benefits of the post-PR may be similar to the pre-PR.

Returning to the discussion of the COLL, as shown at blocks 346 to 352 in FIG. 3C, the PP and SP are complemented with various TD such that the PP and SP are analyzed and compared with the TD, which is provided to the COLL via middleware from the ERP system. Examples of TD that may be provided to the COLL may include: purchases originating from the supplier warehouse as a result of product pre-positioning (block 346); total-territory purchases, which equals supplier warehouse purchases plus non-supplier warehouse purchase (block 348); supply inbounds, which includes inventory positioned into the supplier warehouse (block 350); and supply outbounds, which includes inventory taken from the supplier warehouse to be positioned somewhere else in the supplier network (block 352). Actuals may be used for comparison purposes, alerts, and to project month-end inventory coverages. Region 646 in FIG. 6 shows a table comparing the PP to planned supplier inventory, projected month-end supplier inventory, and supplier purchases.

The CUS and AM may communicate within the COLL by using conversation bubble icons (as shown at region 620 in FIG. 6) related to dialog boxes as previously discussed. Communication between the CUS and AM in the COLL may be facilitated by allowing the CUS to send information and questions to the AM, as shown at block 354.

The AM may amend the PP and SP, as shown at block 356, and respond through the COLL by sending communication back to the CUS, as shown at block 358.
Within the COLL, actions associated with the blocks shown in FIG. 3C may occur in a nonlinear/non-sequential order because of the real-time management of the PP and SP (which includes utilizing the received TD and the collaborative communication between the CUS and AM to update to the PP and SP).

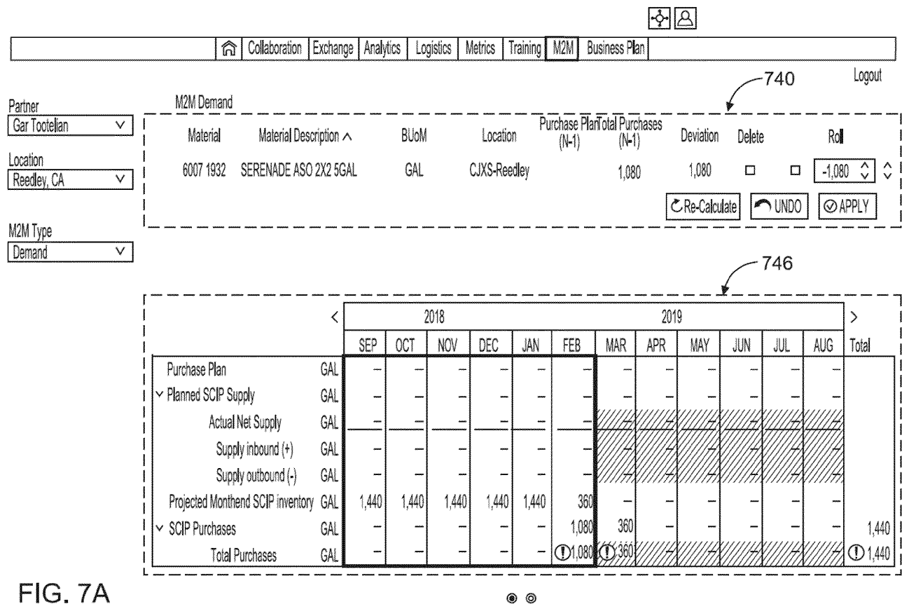

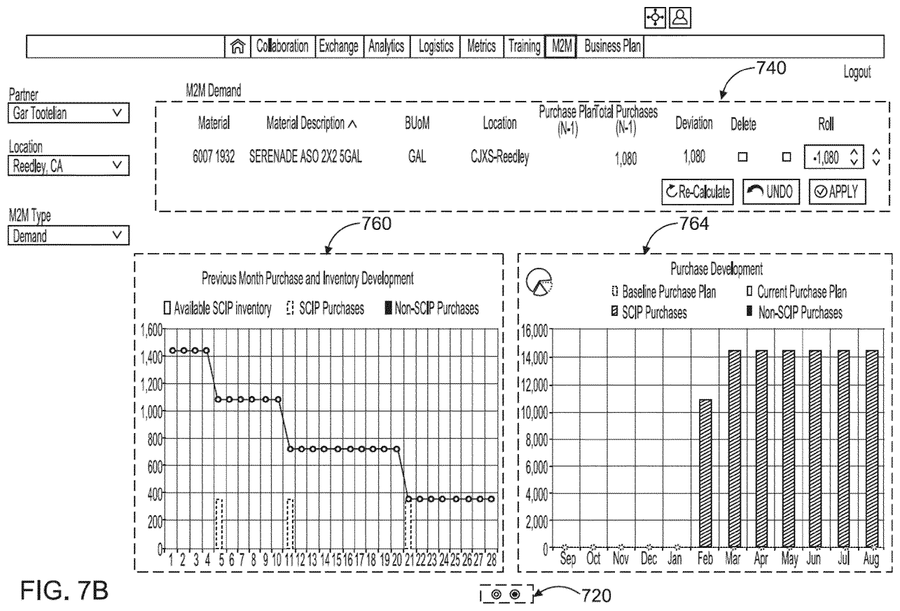

After the conclusion of the updates to the PP and SP, they may be sent to the DEV, as shown at block 360 of FIG. 3D. In the DEV (shown in FIGS. 7A and 7B), the application software captures all deviations for all CUS territory product combination when there is a difference between the PP and total purchases, and the SP and actual net supply. As shown at block 360, the application software may identify a deviation—where the PP for a CUS territory product combination is either greater than or less than total purchases for a previous time interval (e.g., the previous month)—and determine a DV. The AM may then address each deviation based on a decision tree, as shown at block 362.

FIG. 7A shows a first view of the DEV. Region 740 shows a table where the deviations for the previous month are presented for the selected CUS territory. In this table the AM may view the PP, the actuals, and the resulting deviation. The AM may also make a decision to perform the DEL, ROLL, or CURO task. In addition, the buttons at the bottom right of region 740 may allow the user (AM) to undo the task or “recalculate,” which simulates the decision task in the table shown in region 746. In region 746, the table shown is substantially similar to the table shown in the COLL at region 646 (in FIG. 6). The table in region 746 is shown in order to aid the user as a reference when considering the deviation against all the relevant data points.

FIG. 7B shows charts related to the deviation when a radio button is selected in region 720. The chart in region 760 shows the day-by-day development of supplier-owned product (inventory) at the CUS warehouse plus daily sales activity, The “purchase development” chart in region 764 shows how the baseline PP and the current PP compare to the cumulative development of actual purchases.

As stated above, possible deviation scenarios may include scenarios wherein the PP is greater than TP or scenarios wherein the PP is less than TP. As shown at blocks 364A to 364F in FIG. 3D, for each deviation scenario, the AM may make a decision to perform a task with respect to the deviation scenario, which may be one of: TP>PP or TP<PP. The tasks may include: DEL, ROLL, and CURO. In some embodiments, there may be six possible outcomes based on the decision scenarios and the possible tasks that may be performed with respect to the decision scenarios, as shown at blocks 366A to 366F. In some embodiments, every time a task is performed, the application software automatically sets the PP of the previous time interval (e.g., previous month) equal to the TP of the previous time interval. In some embodiments, the SP of the previous time interval is set equal to the actual deliveries of the previous month.

When TP>PP (as shown at blocks 364A to 364C), the following outcomes may be produced based on the task chosen by the AM:
DEL—the DV is not applied to the PP for the current or future months, as shown at block 366A;
ROLL—the DV consumes/reduces the PP, beginning with the current month, until the consumption of the deviation is equal to zero, as shown at block 366B; or
CURO—the DV is overridden (by the AM) to a custom value, and the custom value consumes/reduces the PP, beginning with the current month, until the consumption of the custom value is equal to zero, as shown at block 366C.

When TP<PP (as shown at blocks 364D to 364F), the following outcomes may be produced based on the task chosen by the AM:
DEL—the DV is not applied to the PP for the current or future months, as shown at block 366D;
ROLL—the DV is added to the PP of the current month, as shown at block 366E; or
CURO—the DV is overridden (by the AM) to a custom value, and the custom value is added to the PP of the current month, as shown at block 366F.

After the DEV is completed, the method 300 may return to block 342, as shown in FIGS. 3C and 3B (see off-page reference 3E), where the current and future month PPs may be managed. At the end of the market season, the method 300 may return to block 308 to restart at the PLA.

According to example implementations of the present disclosure, the system 100 and its subsystems including the apparatus 104 and the ERP system 110 may be implemented by various means and may be caused to perform at least the method of any preceding example implementation, or any combination of any preceding example implementation. Means for implementing the system and its subsystems may include hardware, alone or under direction of one or more computer programs from a computer-readable storage medium. In some embodiments, one or more computers may be configured to function as or otherwise implement the system and its subsystems shown and described herein. In some embodiments involving more than one computer, the respective computers may be connected to or otherwise in communication with one another in a number of different manners, such as directly or indirectly via a wired or wireless network (e.g., network 102) or the like.

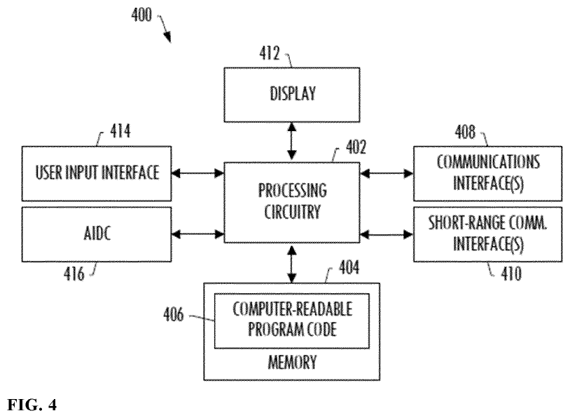

FIG. 4 illustrates a computing apparatus 400 according to some embodiments of the present disclosure. In some embodiments, a computing apparatus may be referred to as a computer and may comprise or be embodied in one or more fixed or portable electronic devices. In some embodiments, the computer may comprise one or more of each of a number of components such as processing circuitry 402 connected to a memory 404 (e.g., storage device). In the case of the apparatus 104, for example, the processing circuitry 402 and memory 404 may correspond to respectively processing circuitry 118 and memory 106.

The processing circuitry 402 may be composed of one or more processors alone or in combination with one or more memories. The processing circuitry is generally any piece of computer hardware that is capable of processing information such as, for example, data, computer programs and/or other suitable electronic information. The processing circuitry is composed of a collection of electronic circuits some of which may be packaged as an integrated circuit or multiple interconnected integrated circuits (an integrated circuit at times more commonly referred to as a “chip”). The processing circuitry may be configured to execute computer programs, which may be stored onboard the processing circuitry or otherwise stored in the memory 404 (of the same or another computer).

The processing circuitry 402 may be a number of processors, a multi-core processor or some other type of processor, depending on the particular implementation. In some embodiments, the processing circuitry may be implemented using a number of heterogeneous processor systems in which a main processor is present with one or more secondary processors on a single chip. In some embodiments, the processing circuitry may be a symmetric multi-processor system containing multiple processors of the same type. In some embodiments, the processing circuitry may be embodied as or otherwise include one or more ASICs, FPGAs or the like. Thus, although the processing circuitry may be capable of executing a computer program to perform one or more functions, the processing circuitry of various examples may be capable of performing one or more functions without the aid of a computer program. In either instance, the processing circuitry may be appropriately programmed to perform functions or operations according to example implementations of the present disclosure.

The memory 404 is generally any piece of computer hardware that is capable of storing information such as, for example, data, computer programs (e.g., computer-readable program code 406) and/or other suitable information either on a temporary basis and/or a permanent basis. In the case of the apparatus 104, this computer-readable program code may include application software 108 and middleware 114. The memory may include volatile and/or non-volatile memory, and may be fixed or removable.

Examples of suitable memory include random access memory (RAM), read-only memory (ROM), a hard drive, a flash memory, a thumb drive, a removable computer diskette, an optical disk, a magnetic tape or some combination of the above. Optical disks may include compact disk-read only memory (CD-ROM), compact disk-read/write (CD-R/W), DVD or the like. In various instances, the memory may be referred to as a computer-readable storage medium. The computer-readable storage medium is a non-transitory device capable of storing information, and is distinguishable from computer-readable transmission media such as electronic transitory signals capable of carrying information from one location to another. Computer-readable medium as described herein may generally refer to a computer-readable storage medium or computer-readable transmission medium.

In addition to the memory 404, the processing circuitry 402 may also be connected to one or more interfaces for displaying, transmitting and/or receiving information. The interfaces may include one or more communications interfaces and/or one or more user interfaces. The communications interface(s) may be configured to transmit and/or receive information, such as to and/or from other computer(s), network(s) or the like. The communications interface may be configured to transmit and/or receive information by physical (wired) and/or wireless communications links. The communications interface(s) may include interface(s) 408 to connect to a network (e.g., network 102), such as using technologies such as cellular telephone, Wi-Fi, satellite, cable, digital subscriber line (DSL), fiber optics and the like. In some examples, the communications interface(s) may include one or more short-range communications interfaces 410 configured to connect devices using short-range communications technologies such as NFC, RFID, Bluetooth, Bluetooth LE, ZigBee, infrared (e.g., IrDA) or the like.

The user interfaces may include a display 412, which may correspond to display 120, and/or one or more user input interfaces 414. The display may be configured to present or otherwise display information to a user, suitable examples of which include a liquid crystal display (LCD), light-emitting diode display (LED), plasma display panel (PDP) or the like. The user input interfaces may be wired or wireless, and may be configured to receive information from a user into the computer 400, such as for processing, storage and/or display. Suitable examples of user input interfaces include a microphone, image or video capture device, keyboard or keypad, joystick, touch-sensitive surface (separate from or integrated into a touchscreen) or the like. In some examples, the user interfaces may include automatic identification and data capture (AIDC) technology 416 for machine-readable information. This may include barcode, radio frequency identification (RFID), magnetic stripes, optical character recognition (OCR), integrated circuit card (ICC), and the like. The user interfaces may further include one or more interfaces for communicating with peripherals such as printers and the like.

As indicated above, program code instructions may be stored in memory, and executed by processing circuitry that is thereby programmed, to implement functions of the systems, subsystems, tools and their respective elements described herein. As will be appreciated, any suitable program code instructions may be loaded onto a computer or other programmable apparatus from a computer-readable storage medium to produce a particular machine, such that the particular machine becomes a means for implementing the functions specified herein. These program code instructions may also be stored in a computer-readable storage medium that can direct a computer, processing circuitry or other programmable apparatus to function in a particular manner to thereby generate a particular machine or particular article of manufacture. The instructions stored in the computer-readable storage medium may produce an article of manufacture, where the article of manufacture becomes a means for implementing functions described herein. The program code instructions may be retrieved from a computer-readable storage medium and loaded into a computer, processing circuitry or other programmable apparatus to configure the computer, processing circuitry or other programmable apparatus to execute operations to be performed on or by the computer, processing circuitry or other programmable apparatus.

Retrieval, loading and execution of the program code instructions may be performed sequentially such that one instruction is retrieved, loaded and executed at a time. In some embodiments, retrieval, loading and/or execution may be performed in parallel such that multiple instructions are retrieved, loaded, and/or executed together. Execution of the program code instructions may produce a computer-implemented process such that the instructions executed by the computer, processing circuitry or other programmable apparatus provide operations for implementing functions described herein.

Execution of instructions by processing circuitry, or storage of instructions in a computer-readable storage medium, supports combinations of operations for performing the specified functions. In some embodiments, a computer 400 may include processing circuitry 402 and a computer-readable storage medium or memory 404 coupled to the processing circuitry, where the processing circuitry is configured to execute computer-readable program code 406 stored in the memory. It will also be understood that one or more functions, and combinations of functions, may be implemented by special purpose hardware-based computer systems and/or processing circuitry which perform the specified functions, or combinations of special purpose hardware and program code instructions.

As explained above, the present disclosure includes any combination of two, three, four or more features or elements set forth in this disclosure, regardless of whether such features or elements are expressly combined or otherwise recited in a specific example implementation described herein. This disclosure is intended to be read holistically such that any separable features or elements of the disclosure, in any of its aspects and example implementations, should be viewed as combinable, unless the context of the disclosure clearly dictates otherwise.

Many modifications and other implementations of the disclosure set forth herein will come to mind to one skilled in the art to which the disclosure pertains having the benefit of the teachings presented in the foregoing description and the associated drawings. Therefore, it is to be understood that the disclosure is not to be limited to the specific implementations disclosed and that modifications and other implementations are intended to be included within the scope of the appended claims. Moreover, although the foregoing description and the associated drawings describe example implementations in the context of certain example combinations of elements and/or functions, it should be appreciated that different combinations of elements and/or functions may be provided by alternative implementations without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method of supply chain management from an apparatus with application software coupled with an enterprise resource planning (ERP) system via middleware, the method comprising:
executing the application software to cause the apparatus to generate a visual environment including a graphical user interface (GUI), including the apparatus:
initiating a planning module of the GUI for:
building a portfolio including one or more products and based at least in part on a plurality of input data feeds and selected criteria including a customer;
selecting a product of the one or more products and inputting a purchase plan based at least in part on the selected product and the customer; and
performing an analysis of the purchase plan and outputting the purchase plan to a collaboration module of the GUI;
initiating the collaboration module for:
generating a supply plan based on the purchase plan;
comparing the purchase plan and the supply plan to transactional data received from the ERP system via the middleware;
modifying the purchase plan and the supply plan based at least in part on communication between the customer and an application manager after the comparing step; and
outputting the modified purchase plan and the modified supply plan to a deviation management module of the GUI; and
initiating the deviation management module for:
determining whether the modified purchase plan should be adjusted based on a deviation value that is calculated when a deviation exists in the modified purchase plan; and
performing a task to delete, roll, or custom roll the deviation value in the modified purchase plan based on the determining step.

2. An apparatus for supply chain management, the apparatus comprising:
a memory storing application software coupled with an enterprise resource planning (ERP) system via middleware; and processing circuitry configured to access the memory and execute the application software to cause the apparatus to generate a visual environment including graphical user interface (GUI), including the apparatus being caused to at least:
initiate a planning module of the GUI, the planning module configured to:
build a portfolio including one or more products and based at least in part on a plurality of input data feeds and selected criteria including a customer;
select a product of the one or more products and inputting a purchase plan based at least in part on the selected product and the customer; and
perform an analysis of the purchase plan and outputting the purchase plan to a collaboration module of the GUI;
initiate the collaboration module configured to:
generate a supply plan based on the purchase plan;
compare the purchase plan and the supply plan to transactional data received from the ERP system via the middleware;
modify the purchase plan and the supply plan based at least in part on communication between the customer and an application manager after the comparison; and
output the modified purchase plan and the modified supply plan to a deviation management module of the GUI; and
initiate the deviation management module configured to:
determine whether the modified purchase plan should be adjusted based on a deviation value that is calculated when a deviation exists in the modified purchase plan; and
perform a task to delete, roll, or custom roll the deviation value in the modified purchase plan based on the determination.

3. A computer-readable storage medium for supply chain management, the computer-readable storage medium being non-transitory and having stored therein computer r-readable program code coupled with an enterprise resource planning (ERP) system via middleware, the computer-readable program code being executable by processing circuitry to cause an apparatus to:
generate a visual environment including graphical user interface (GUI), including the apparatus being caused to at least:
initiate a planning module of the GUI, the planning module configured to:
build a portfolio including one or more products and based at least in part on a plurality of input data feeds and selected criteria including a customer;
select a product of the one or more products and inputting a purchase plan based at least in part on the selected product and the customer; and
perform an analysis of the purchase plan and outputting the purchase plan to a collaboration module of the GUI;
initiate the collaboration module configured to:
generate a supply plan based on the purchase plan;
compare the purchase plan and the supply plan to transactional data received from the ERP system via the middleware;
modify the purchase plan and the supply plan based at least in part on communication between the customer and an application manager after the comparison; and
output the modified purchase plan and the modified supply plan to a deviation management module of the GUI; and
initiate the deviation management module configured to:
determine whether the modified purchase plan should be adjusted based on a deviation value that is calculated when a deviation exists in the modified purchase plan; and
perform a task to delete, roll, or custom roll the deviation value in the modified purchase plan based on the determination.
